(19) United States
(12) Patent Application Publication
(10) Pub. No.: US 2026/0316468 A1
(43) Pub. Date: Oct. 15, 2026

(54) METHOD AND MANUFACTURING METHOD OF ROLL ATTACHED TO ROLL HOLDER

(71) Applicant: Brother Kogyo Kabushiki Kaisha, Nagoya (JP)

(72) Inventors: Makoto Nomura, Shizuoka (JP); Yushi Kato, Nagoya (JP); Yuki Hiramatsu, Nukata (JP)

(21) Appl. No.: 19/463,394

(22) Filed: Jan. 29, 2026

(30) Foreign Application Priority Data
Jan. 31, 2025 (JP) 2025-015603

(51) Int. Cl. B41J 15/02; B41J 3/407; B41J 15/04

(52) U.S. Cl. CPC B41J 15/02; B41J 3/4075; B41J 15/042

(57) ABSTRACT

A method includes providing a roll holder including a memory, the roll holder configured to allow a roll around which a sheet is wound to be attached, attaching the roll to the provided roll holder and writing, by a writing device, information related to the roll into the memory.

### TECHNICAL FIELD

This application claims priority from Japanese Patent Application No. 2025-015603 filed on Jan. 31, 2025. The entire content of the priority application is incorporated herein by reference.

### BACKGROUND

The tape printing device described in Patent Document 1 prints characters and/or other information onto an elongated sheet consisting of an adhesive sheet laminated with release paper, using a thermal head. The sheet to be printed is wound around a hollow core to form a roll. The roll is mounted to a roll holder, where the core is rotatably supported. A plurality of rolls, which have various sheet widths respectively, can be attached to the roll holder. The roll holder is supported inside the tape printing device by a support mechanism in a state where the roll holder is detachably attached to the tape printing device.

### SUMMARY

If a memory storing the thermal head’s control parameters is attached to the roll holder, it becomes possible to use various types of rolls that require different thermal head control parameters. Therefore, there is a need for new technology that provides rolls equipped with a roll holder containing such memory.

The objective of the present disclosure is to provide new technology for supplying rolls equipped with a roll holder that includes memory.

A method according to one aspect of the present disclosure may include providing a roll holder including a memory, the roll holder configured to allow a roll around which a sheet is wound to be attached, attaching the roll to the provided roll holder; and writing, by a writing device, information related to the roll into the memory.

A method for manufacturing a roll attached to a roll holder according to another aspect of the present disclosure may include attaching a roll around which a sheet is wound to the roll holder including a memory; and writing, by a writing device, information related to the roll into the memory.

In the present disclosure, for various types of rolls, information related to each roll can be written into the memory of the holder.

### BRIEF DESCRIPTION OF THE DRAWINGS

FIG. 1 is a perspective view of the printer 1 with the cover 12 placed in the open position.

FIG. 2(A) is a perspective view of the roll core 93, and FIG. 2(B) is a perspective view of the roll 90.

FIG. 3 is a perspective view of the roll holder 91.

FIG. 4 is a block diagram showing the electrical configuration of the printer 1.

FIG. 5 is a flowchart of the sample production process of the first manufacturing and supplying method.

FIG. 6 is a flowchart of the mass production process of the first manufacturing and supplying method.

FIG. 7 is a flowchart of the sample creation process of the second manufacturing and supplying method.

FIG. 8 is a flowchart of the mass production process of the second manufacturing and supplying method.

FIG. 9 is a flowchart of the sample creation process of the third manufacturing and supplying method.

FIG. 10 is a flowchart of the mass production process of the third manufacturing and supplying method.

### DETAIL DESCRIPTION

An embodiment of the present disclosure will be described below with reference to the drawings. The drawings referenced herein are used to explain the technical features that the present disclosure can employ. The configurations of the devices described are merely illustrative examples and are not intended to limit the disclosure thereto.

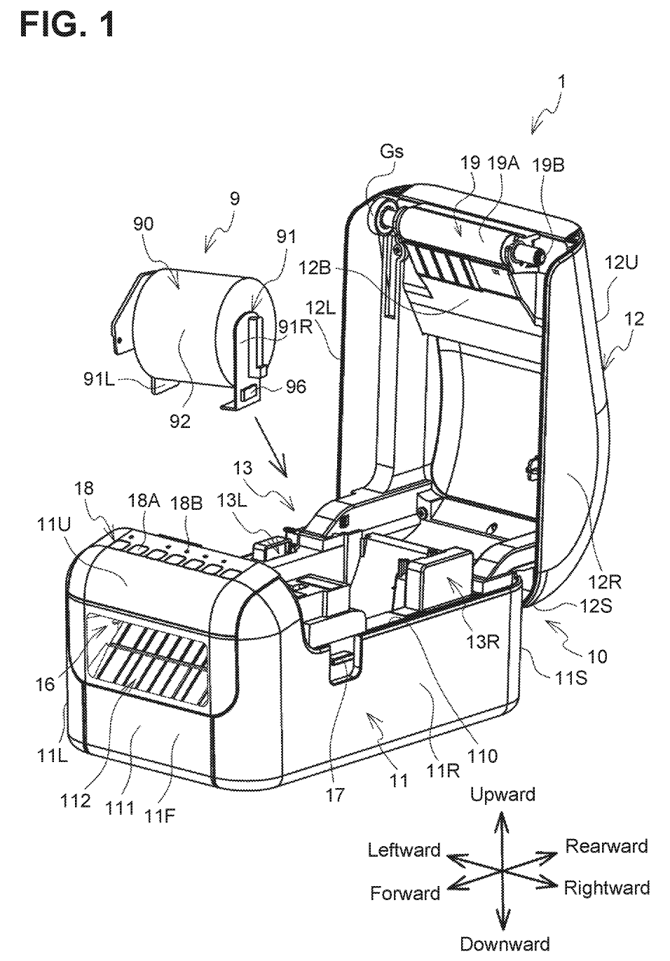

As shown in FIG. 1, the roll 90, to which the roll holder 91 is attached, is mounted to the printer 1. Hereinafter, the roll 90, to which the roll holder 91 is attached, is referred to as the roll unit 9. In FIG. 1, the upward, downward, lower left diagonal, upper right diagonal, upper left diagonal, and lower right diagonal directions correspond respectively to upward, downward, forward, rearward, leftward, and rightward directions of the printer 1. First, the printer 1 will be described.

### Overview of Printer 1

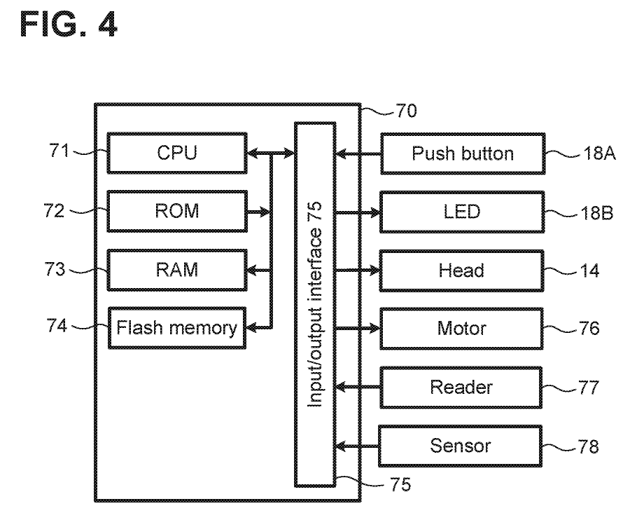

The printer 1 performs printing using a thermal printing method. The printer 1 feeds out a media sheet 92 from the roll 90 around which the media sheet 92 is wound. The media sheet 92 is a thermal medium that develops color when heated. The printer 1 heats the media sheet 92 fed from the roll 90 using the head 14 shown in FIG. 4. When the media sheet 92 develops color, printing is performed thereon. The printer 1 cuts off the printed portion of the media sheet 92 from the roll 90 using a cutter unit. The cut portion of the media sheet 92 is produced as a printed label.

As shown in FIG. 1, the printer 1 includes a housing 10. The housing 10 includes a main body 11 and a cover 12. The main body 11 includes a front wall portion 11F, a rear wall portion 11S, a left wall portion 11L, a right wall portion 11R, an upper wall portion 11U, and a lower wall portion 11B.

The front wall portion 11F includes a first wall portion 111 that is perpendicular to the front rear direction, and a second wall portion 112 that extends inward from the first wall portion 111. At the inner end of the second wall portion 112, a discharge port (in other words, a discharged opening) 16 is provided through which the printed portion of the media sheet 92 is discharged. The printed portion of the media sheet 92 is discharged from the discharge port 16. The upper end of the rear wall portion 11S rotatably supports the cover 12.

At the upper wall portion 11U, an interface panel 18 is provided. The interface panel 18 includes a plurality of push buttons 18A and LEDs 18B. The push buttons 18A are operated by the user to input commands to the printer 1. The LEDs 18B indicate the status of the printer 1. A lever 17 is provided on the right wall portion 11R for opening the cover 12. The main body 11 includes an accommodating section 13 inside. The accommodating section 13 forms a space for accommodating the roll unit 9.

### Structure of Roll Unit 9

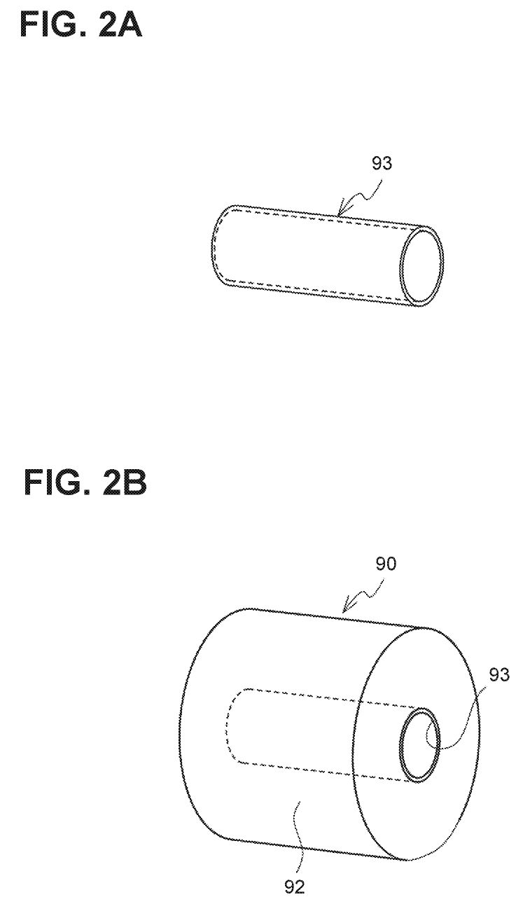

The structure of the roll unit 9 will be described with reference to FIGS. 1 to 3. The roll unit 9 is the roll 90 being attached to the roll holder 91. As shown in FIG. 2(B), the roll 90 has a long media sheet 92, which has a fixed width and is wound around the roll core 93. As shown in FIG. 2(A), an example of the roll core 93 is a cylindrical paper tube. The media sheet 92 is a sheet having a thermosensitive label on a surface of the media sheet 92. The roll 90 can use various types of media sheets 92 having labels of different shapes.

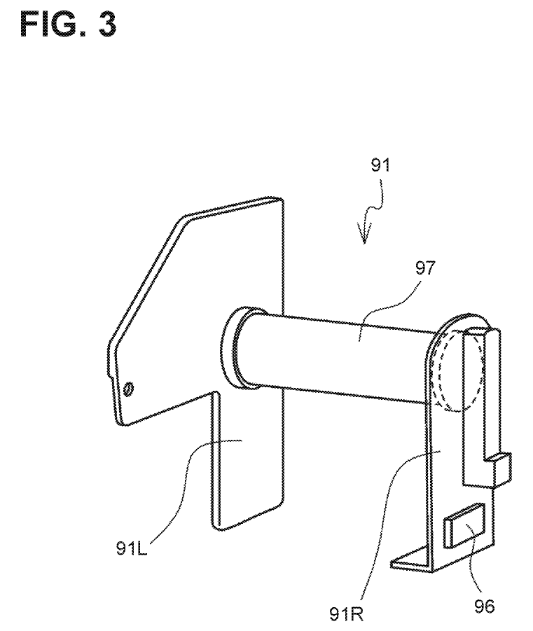

As shown in FIG. 1, the roll holder 91 rotatably supports the roll 90. As shown in FIG. 3, the roll holder 91 includes a shaft 97 that passes through the center of the roll 90 and flange 91L is provided at one side of the shaft 97 and flange 91R is provided at another side of the shaft 97. The flange 91L is located at the left side of the roll 90, and the flange 91R is located at the right side of the roll 90. The roll holder 91 can rotatably hold rolls 90 having different lengths in the left right direction.

A memory 96 is provided at the right surface of the flange 91R. The memory 96 is non volatile memory. The memory 96 stores at least one of the management number of the roll unit 9, the width of the media sheet 92, and parameter data indicating the heating conditions of the head 14 when printing on the media sheet 92.

As shown in FIG. 1, unit support portions 13L and 13R are provided in the accommodating section 13 of the printer 1. The unit support portion 13L supports the flange 91L of the roll unit 9 in a state where the roll unit 9 is accommodated in the accommodating section 13. The unit support portion 13R supports the flange 91R of the roll unit 9 in a state where the roll unit 9 is accommodated in the accommodating section 13.

On the left surface of the unit support portion 13R, a reader 77 and a sensor 78 shown in FIG. 4 are provided. The reader 77 has electrodes. The electrodes of the reader 77 electrically connect with the electrodes of the memory 96 when the roll unit 9 is accommodated in the accommodating section 13. The reader 77 can read specific data stored in the memory 96 through the electrodes.

The sensor 78 is a contact type switch. The sensor 78 outputs different signals depending on whether or not the roll unit 9 is accommodated in the accommodating section 13. The sensor 78 is used to detect whether the roll unit 9 is accommodated in the accommodating section 13.

A head 14 is provided in front of the accommodating section 13. The head 14 has multiple heating elements on its upper surface. A spring connected to the lower end of the head 14 biases the head upward.

A cutter unit is provided in front of the head 14 and behind the discharge port 16. The cutter unit includes a pair of cutters. The media sheet 92 passes forward between the pair of cutters. When the pair of cutters move toward each other, the media sheet 92 is cut. Thus, the printed portion of the media sheet 92 is separated from the roll 90.

The upper ends of the front wall portion 11F, rear wall portion 11S, left wall portion 11L, and right wall portion 11R, and the rear end of the upper wall portion 11U form an opening 110 in the main body 11. The lower wall portion 11B faces the mounting surface when the printer 1 is placed on the mounting surface.

The cover 12 is movable between a closed position in which the cover 12 closes the opening 110 of the main body 11 and an open position in which the cover 13 does not close the opening 110 of the main body 11. FIG. 1 shows the cover 12 in the open position. Hereinafter, unless otherwise noted, descriptions regarding each of directions (upward, downward, forward, backward, leftward, and rightward) of the cover 12 are explained as follows, given that the cover 12 is in the closed position.

The cover 12 includes an upper wall portion 12U, a left wall portion 12L, a right wall portion 12R, and a rear wall portion 12S. The upper wall portion 12U is positioned behind the upper wall portion 11U of the main body 11. The left wall portion 12L is positioned above the left wall portion 11L of the main body 11. The right wall portion 12R is positioned above the right wall portion 11R. The rear wall portion 12S is positioned above the rear wall portion 11S. The lower end of the rear wall portion 12S is rotatably supported on the upper end of the rear wall portion 11S.

A platen assembly 19 is rotatably supported at the front end of the lower surface of the upper wall portion 12U. The platen assembly 19 includes a platen roller 19A, a shaft 19B, and an idler gear Gs.

The platen roller 19A has a cylindrical shape. The shaft 19B includes a portion protruding leftward from the left end of the platen roller 19A and a portion protruding rightward from the right end. A bearing 12B provided at the upper wall portion 12U of the cover 12 rotatably supports the shaft 19B of the platen assembly 19.

An idler gear Gs is connected to the portion of the shaft 19B protruding leftward from the left end of the platen roller 19A.

When the cover 12 is in the closed position, the platen roller 19A is positioned above the head 14. The idler gear Gs meshes with a main gear provided in the main body 11. A motor 76 is connected to the main gear.

The driving force produced by the rotation of the motor 76 is transmitted to the platen roller 19A through the main gear and the idler gear Gs. As a result, the platen roller 19A rotates and feeds out the media sheet 92 from the roll 90.

The media sheet 92 fed out from the roll 90 passes between the head 14 and the platen roller 19A. Because the head 14 is biased upward by a spring, the head 14 presses against the media sheet 92. In this state, multiple heating elements of the head 14 generate heat, causing the media sheet 92 to develop color. Thus, printing is performed on the media sheet 92. The printed portion of the media sheet 92 is cut from the roll by the cutter unit and discharged from the discharge port 16.

### Electrical Configurations

With reference to FIG. 4, the electrical configuration of the printer 1 will be described. The printer 1 includes a control board 70. The control board 70 has a CPU (Central Processing Unit) 71, ROM (Read Only Memory) 72, RAM (Random Access Memory) 73, a flash memory 74, and an input/output interface 75 electrically connected to each other.

The CPU 71 controls the operation of the printer 1. The ROM 72 stores various parameters and printer type information required when the CPU 71 executes various programs. The RAM 73 temporarily stores calculation results and other information. The flash memory 74 stores programs is configured to be executed by the CPU 71.

The input/output interface 75 is electrically connected to the push buttons 18A, LEDs (Light Emitting Diodes) 18B, the head 14, the motor 76, the reader 77, and the sensor 78.

### Manufacturing Method and Supply Method for a Roll Unit

In the following description, the manufacturer of the printer 1 is referred to as the printer manufacturer. The manufacturer of the roll 90 is referred to as the roll provider. The manufacturer of the roll holder 91 is referred to as the holder provider.

### The First Manufacturing and Supplying Method

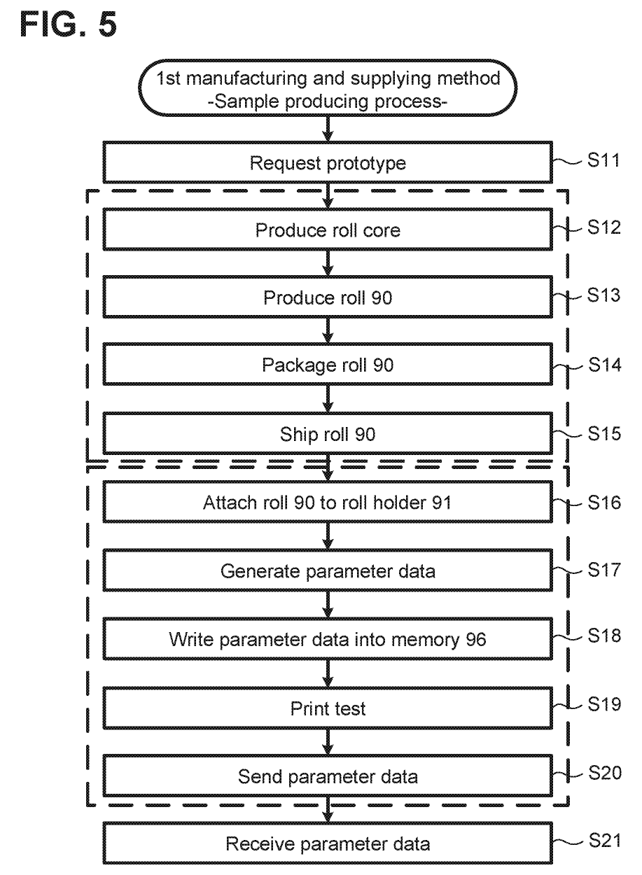

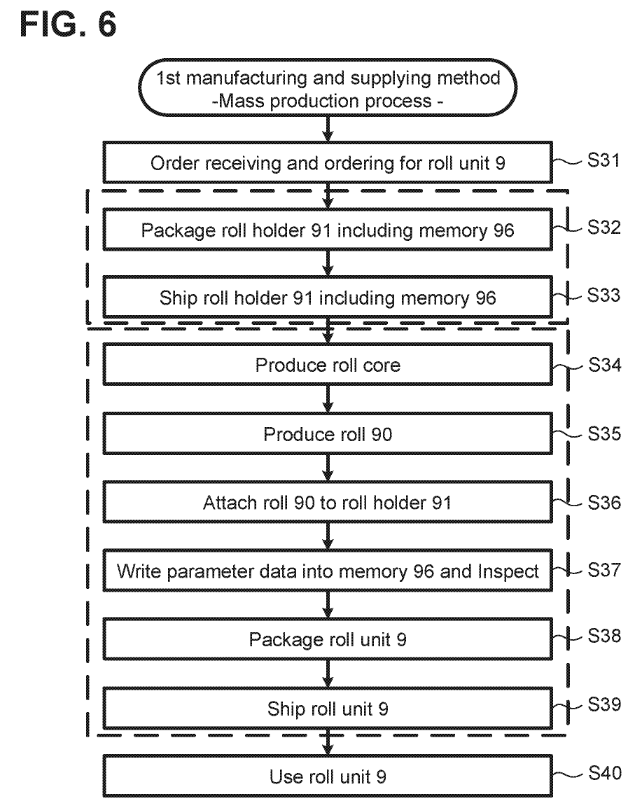

With reference to FIGS. 5 and 6, the first manufacturing and supplying method will be described. In the mass-production process of the first method, the roll provider performs producing the roll 90, attachment of the roll holder 91 to the roll 90, writing of parameter data into the memory 96, shipment of the roll unit 9, and other related operations.

### Sample Producing Process

First, with reference to FIG. 5, the sample producing process of the first manufacturing and supplying method for the roll unit 9 will be described. In the sample producing process, the printer manufacturer requests the roll provider to make prototype roll units 9 (S11). For this prototype request, data representing the specification sheet prepared by the printer manufacturer’s computer and the written request for prototyping is transmitted from the printer manufacturer’s computer to the roll provider’s computer (S11).

The specification sheet describes at least the size and material of the roll 90. The written prototype request describes at least the quantity of rolls 90 to be prototyped and the shipment destination of the rolls 90 for the roll provider.

At the roll provider, steps S12 to S15 enclosed by the upper dashed box in FIG. 5 are performed. Based on the data representing the specification sheet and the prototype request received by the roll provider’s computer, the roll provider first manufactures the roll cores 93. The number of roll core samples to be produced corresponds to the quantity specified in the prototype request and roll core samples corresponds to the quantity are produced (S12). Next, the roll provider winds the media sheet 92 around each roll core 93 to produce the rolls 90 (S13). The rolls 90 are produced in the sizes and materials specified in the specification sheet, and in the quantities indicated in the prototype request. The produced roll 90 is then packaged (S14), after which the packaged roll 90 is shipped to the printer manufacturer (S15).

### Printer Manufacturer’s Operation

Steps S16 to S20 enclosed by the lower dashed box in FIG. 5 are performed at the printer manufacturer. The printer manufacturer attaches the roll 90 received from the roll provider to the roll holder 91 (S16). Then, parameter data is generated by the printer manufacturer’s computer (S17). In step S17, a data file , which includes printing parameters indicating the heating conditions of the head during printing onto the media sheet, is generated as the parameter data. Next, using a ROM (Read Only Memory) writer via the printer manufacturer’s computer, the parameter data is written into the memory 96 of the roll holder 91 (S18). Instead of the printer manufacturer’s computer, the printer may include the ROM writer. In that case, the printer manufacturer writes the parameter data into the memory 96 by using the printer 1. Specifically, the roll holder 91 including the memory 96 is mounted to the printer 1, and the CPU 71 of the printer 1 writes the parameter data into the memory 96 via the ROM writer.

Next, the roll unit 9 in which the parameter data has been written in step S18 is mounted on the printer 1, and a print test is performed (S19). The printer 1 used for the print test is the same model as the printer that will be used by a user. When the print test result satisfies the specification, the parameter-data file is sent from the printer manufacturer’s computer to the roll provider’s computer (S20). The parameter data may also be converted into a batch file executable by the roll provider’s computer, and this batch file may be sent to the roll provider’s computer (S20). The roll provider’s computer receives the parameter-data file or batch file sent from the printer manufacturer’s computer (S21).

### Mass Production Process

With reference to FIG. 6, the mass-production process of the roll unit 9 in the first manufacturing and supplying method will be described. First, the printer manufacturer performs an order receiving process and an ordering process for the roll units 9 (S31). Specifically, the printer manufacturer’s computer sends instructions to the warehouse department’s computer to ship to the roll provider the quantity of roll holders 91 required for mass production of roll units 9 corresponding to the number of customer orders (S31). The printer manufacturer’s computer also sends the mass-production specification sheet and the mass-production request document to the roll provider’s computer (S31).

The specification sheet describes at least the type of roll unit 9. The mass-production request document describes at least the quantity of roll units 9 to be mass-produced and the shipment destination of the roll units 9.

The warehouse department packages the required quantity of roll holder 91 including memory 96 (S32). Then, the warehouse department ships the packaged roll holders 91 to the roll provider (S33). Note that in the mass-production process of the first manufacturing and supplying method, the warehouse department of the printer manufacturer serves as the holder provider.

At the roll provider, steps S34 to S39 enclosed by the lower dashed box in FIG. 6 are performed. Based on the specification sheet and mass-production request received from the printer manufacturer, the roll provider produces the necessary number of roll cores 93 for mass production (S34). Next, the roll provider winds the media sheet 92 around the roll cores 93 to produce the rolls 90 (S35). The rolls 90 are produced in the sizes and materials used for the type of roll unit 9 described in the specification sheet, and in the quantities indicated in the mass-production request.

The mass-produced roll 90 is then attached to the roll holder 91, as a result, the roll unit 9 is assembled (S36). Next, parameter data is written into the memory 96 of the roll holders 91 using the roll provider’s computer (S37). The parameter data written is the data received in step S21 in FIG. 5. The printer 1, instead of the roll provider’s computer, may have a ROM writer. In that case, the roll provider uses the printer 1 to write the parameter data into the memory 96. Specifically, the roll holder 91 including the memory 96 is mounted on the printer 1, and the CPU 71 of the printer 1 writes the parameter data into the memory 96 via the ROM writer. The roll unit 9 is then inspected (S37). The roll unit 9 that passes inspection is packaged (S38).

Next, the packaged roll unit 9 is shipped to the user (S39). On the shipping documents, the sender’s address and name are listed as the address and name of the printer manufacturer. The roll unit 9 is mounted in the printer 1 by the user and the roll unit 9 is used (S40). Since the memory 96 of the roll holder 91 stores parameter data suitable for printing in the printer 1, the printing result onto the media sheet 92 is favorable.

### The Second Manufacturing and Supplying Method

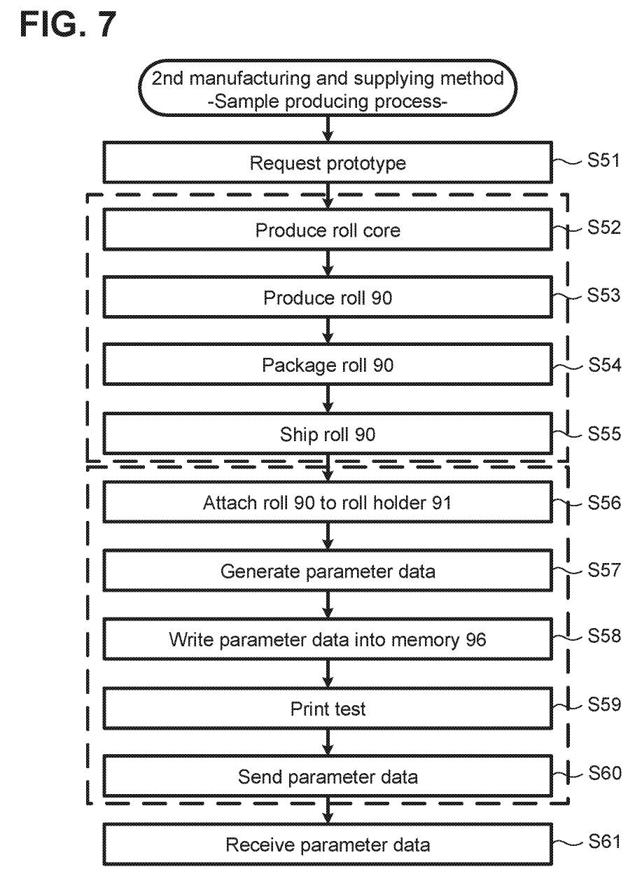

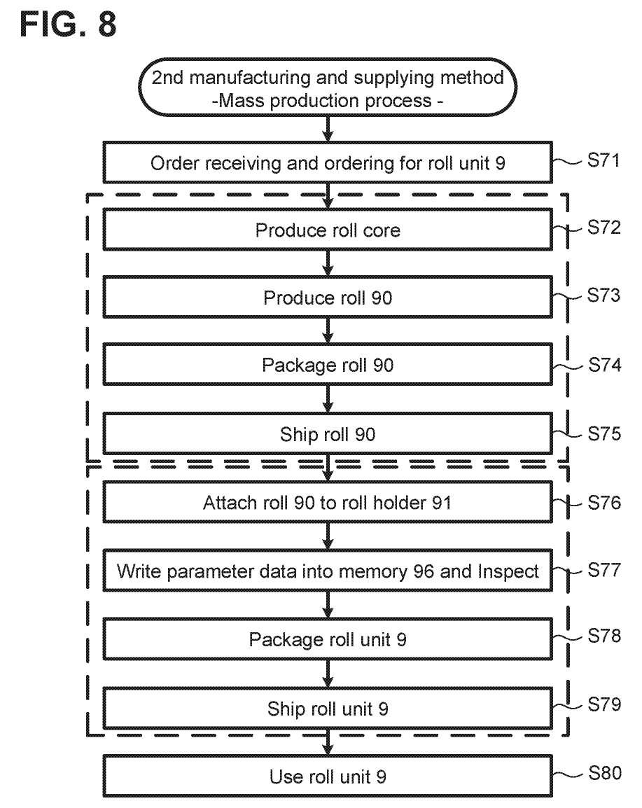

With reference to FIGS. 7 and 8, the second manufacturing and supplying method will be described. In the mass production process of the second method, the printer manufacturer’s factory performs attachment of the roll holder 91 to the roll 90, writing of parameter data into the memory 96, shipment of the roll unit 9, and other operations. The printer manufacturer’s factory may be located overseas. For example, it may be the manufacturer’s factory in the United States or the United Kingdom.

First, with reference to FIG. 7, the sample producing process of the second manufacturing and supplying method for the roll unit 9 will be described. In this process, the printer manufacturer requests the roll provider to produce prototype roll units 9 (S51). For this request, data representing the specification sheet made by the printer manufacturer’s computer and the written prototype request are transmitted from the printer manufacturer’s computer to the roll provider’s computer (S51).

The specification sheet describes at least the size and material of the roll 90. The written prototype request describes at least the number of rolls 90 to be prototyped and their shipment destination.

At the roll provider, steps S52 to S55 enclosed by the upper dashed box in FIG. 7 are performed. Based on the specification sheet and prototype request received by the roll provider’s computer, the roll provider, first, produces the roll core 93 (S52). The number of sample roll cores produced corresponds to the number described in the prototype request and roll core samples corresponds to the quantity are produced. Next, the roll provider winds the media sheet 92 around each roll core 93 to produce the rolls 90 (S53). The roll 90 is produced in the sizes and materials described in the specification sheet, and in the quantities specified in the prototype request. The produced roll 90 is then packaged (S54) and shipped to the printer manufacturer (S55).

### Printer Manufacturer’s Operation

At the printer manufacturer, steps S56 to S60 enclosed by the lower dashed box in FIG. 7 are performed. The printer manufacturer mounts the rolls 90 received from the roll provider onto the roll holders 91 (S56). Next, parameter data is generated by the printer manufacturer’s computer (S57). Then, the parameter data is written into the memory 96 of the roll holder 91 by the printer manufacturer’s computer (S58). Alternatively, instead of using the printer manufacturer’s computer, the printer 1 may include a ROM writer. In that case, the printer manufacturer uses the printer 1 to write the parameter data into the memory 96. Specifically, the roll holder 91 including the memory 96 is mounted on the printer 1, and the CPU 71 of the printer 1 writes the parameter data into the memory 96 via the ROM writer.

Next, the roll unit 9 including the memory 96 storing the parameter data written in step S58 is mounted on the printer 1, and a print test is performed (S59). The printer 1 used for the print test is the same model as the printer used by a user. When the print test result satisfies the specification, the parameter data is sent from the printer manufacturer’s computer to the computer at the printer manufacturer’s factory (S60).

The printer manufacturer’s factory computer receives the parameter data sent from the printer manufacturer’s computer (S61).

### Mass-Production Process

With reference to FIG. 8, the mass-production process of the roll unit 9 in the second manufacturing and supplying method will be described. First, the printer manufacturer performs order receiving process and an ordering process for the roll units 9 (S71). Specifically, the printer manufacturer’s computer sends the mass-production specification sheet and the mass-production request document to the roll provider’s computer (S71). The same specification sheet and mass-production request document are also sent to the printer manufacturer’s factory computer (S71).

The specification sheet describes at least the type of roll unit 9. The mass-production request document describes at least the number of roll units 9 to be mass-produced and their shipment destination.

At the roll provider, steps S72 to S75 enclosed by the upper dashed box in FIG. 8 are performed. Based on the specification sheet and mass-production request received by the roll provider’s computer, the required number of roll cores 93 are produced(S72). Next, the roll provider winds the media sheet 92 around the roll cores 93 to produce the rolls 90 (S73). The rolls 90 are produced in the sizes and materials used for the type of roll unit 9 described in the specification sheet, and in the quantities specified in the mass-production request. The produced rolls 90 are then packaged (S74) and shipped to the printer manufacturer’s factory (S75).

### Operations at the Printer Manufacturer’s Factory

At the printer manufacturer’s factory, steps S76 to S79 enclosed by the lower dashed box in FIG. 8 are performed. Based on the specification sheet and mass-production request received from the printer manufacturer, the roll unit 9 is assembled (S76). In step S76, the roll 90 received from the roll provider is attached to the roll holder 91, the roll unit 9 is assembled. Note that in the mass-production process of the second manufacturing and supplying method, the printer manufacturer’s factory serves as the holder provider. Next, parameter data is written into the memory 96 of the roll holders 91 by the factory’s computer (S77). The parameter data written is the data received in step S61 in FIG. 7. Alternatively, instead of using the factory’s computer, the printer 1 may include a ROM writer. In that case, a factory worker uses the printer 1 to write the parameter data into the memory 96. Specifically, the roll holder 91 including the memory 96 is mounted on the printer 1, and the CPU 71 writes the parameter data into memory 96 via the ROM writer.

Next, inspection of the roll units 9 is performed (S77). The Roll unit 9 that passes inspection is packaged (S78). The packaged roll unit 9 is then shipped from the printer manufacturer’s factory to the user (S79). The user mounts the shipped roll unit 9 into the printer 1 and uses the roll unit 9 (S80). Since the memory 96 of the roll holder 91 includes parameter data suitable for printing with the printer 1, the printing result on the media sheet 92 is favorable.

### The Third Manufacturing and Supplying Method

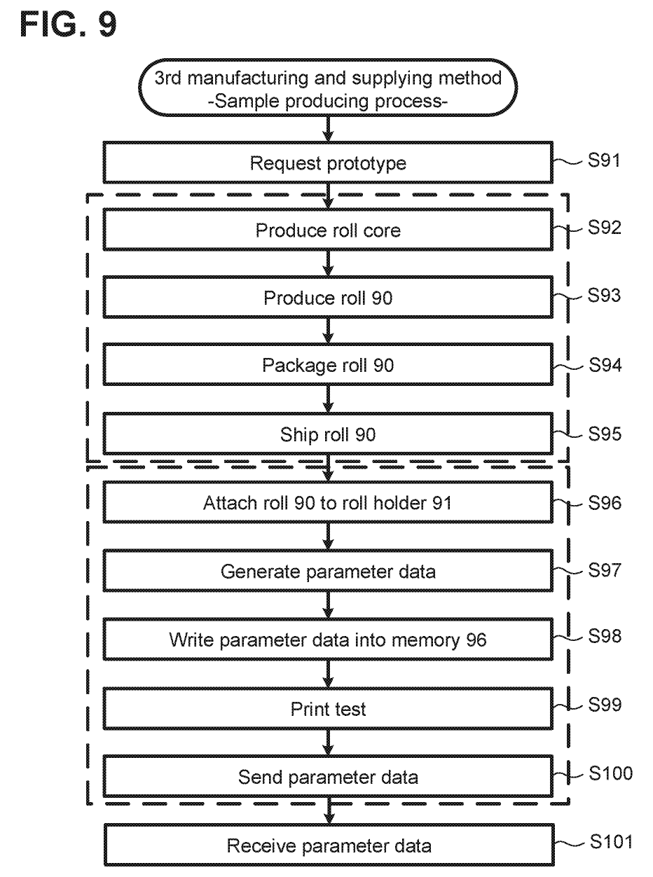

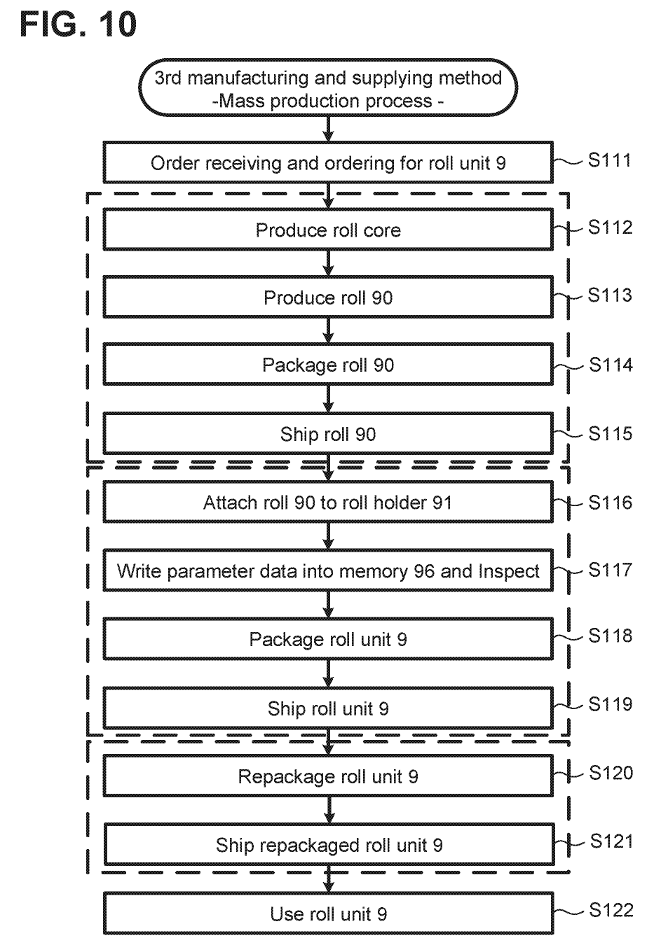

With reference to FIGS. 9 and 10, the third manufacturing and supply method will be described. In the mass production process of this method, the printer manufacturer’s factory performs the attachment of the roll holder 91 to the roll 90 and the writing of parameter data into the memory 96. The warehouse department of the printer manufacturer performs shipment of the roll units 9 and other related operations. The printer manufacturer’s factory may be located overseas. For example, the factory may be an Asian regional factory of the printer manufacturer.

With reference to FIG. 9, the sample producing process of the third manufacturing and supplying method for the roll unit 9 will be described. In this process, the printer manufacturer requests the roll provider to prototype the roll units 9 (S91). For this request, data representing the specification sheet and prototype request—both generated by the printer manufacturer’s computer—is transmitted from the printer manufacturer’s computer to the roll provider’s computer (S91). The roll provider may be a roll provider located in the Asian region.

The specification sheet describes at least the size and material of the roll 90. The prototype request document describes at least the number of rolls 90 to be prototyped and the printer manufacturer as the shipment destination.

At the roll provider, steps S92 to S95 enclosed by the upper dashed box in FIG. 9 are performed. Based on the data representing the specification sheet and the prototype request received by the roll provider’s computer, the roll core 93 is first produced (S92). The number of roll cores produced corresponds to the quantity specified in the prototype request. Next, the media sheet 92 is wound around each roll core 93 to produce the rolls 90 (S93). The rolls 90 are produced in the sizes and materials described in the specification sheet and in the quantities specified in the prototype request. The produced roll 90 is then packaged (S94) and shipped to the printer manufacturer (S95). Preferably, the roll provider is located near the printer manufacturer’s Asian factory.

### Printer Manufacturer’s Operation

At the printer manufacturer’s factory, steps S96 to S100 enclosed by the lower dashed box in FIG. 9 are performed. The printer manufacturer attaches the rolls 90 received from the roll provider to the roll holders 91 (S96). Next, parameter data is generated by the printer manufacturer’s computer (S97). Then, the parameter data is written into the memory 96 of the roll holder 91 (S98). Alternatively, instead of the printer manufacturer’s computer, the printer 1 may include a ROM writer. In that case, the printer manufacturer uses the printer 1 to write the parameter data into the memory 96. Specifically, the roll holder 91 including the memory 96 is mounted on the printer 1, and the CPU 71 writes the parameter data into the memory 96 via the ROM writer.

Next, the roll unit 9 including the memory 96 storing the parameter data was written in step S98 is mounted on the printer 1, and a print test is performed (S99). The printer 1 used for the print test is the same model as the one used by a user. When the print test result satisfies the specification, the parameter data is sent from the printer manufacturer’s computer to the computer at the printer manufacturer’s factory (S100).

The printer manufacturer’s factory computer receives the parameter data sent from the printer manufacturer’s computer (S101).

Mass-Production Process With reference to FIG. 10, the mass-production process of the roll unit 9 in the third manufacturing and supplying method will be described. First, the printer manufacturer performs order receiving process and an ordering process for the roll units 9 (S111). Specifically, the printer manufacturer’s computer sends the mass-production specification sheet and mass-production request to the roll provider’s computer (S111). The roll provider may be an Asian roll provider. The same documents are also sent to the printer manufacturer’s factory computer (S111). Preferably, the factory is the Asian regional factory located near the roll provider.

The specification sheet describes at least the type of roll unit 9. The mass-production request describes at least the number of roll units 9 to be mass-produced and shipment destination of the roll units 9.

Roll Provider’s Operation At the roll provider, steps S112 to S115 enclosed by the upper dashed box in FIG. 10 are performed. Based on the specification sheet and mass-production request received by the roll provider’s computer, the necessary number of roll cores 93 are produced (S112). Next, the media sheet 92 is wound around each roll core 93 to produce the rolls 90 (S113). The rolls 90 are produced in the sizes and materials used for the type of roll unit 9 described in the specification sheet and in the quantities specified in the mass-production request. The produced rolls 90 are then packaged (S114) and shipped to the printer manufacturer’s factory (S115).

### Operations at the Printer Manufacturer’s Factory

At the printer manufacturer’s factory, steps S116 to S119 enclosed by the lower dashed box in FIG. 10 are performed. Based on the specification sheet and mass-production request received from the printer manufacturer, the roll 90 received from the roll provider is attached to the roll holder 91, the roll unit 9 is assembled (S116). In the mass-production process of the third method, the Asian regional factory of the printer manufacturer serves as the holder provider. Next, the parameter data is written into the memory 96 of the roll holder 91 by the factory’s computer (S117). The parameter data written corresponds to the data received in step S101 in FIG. 9. Alternatively, instead of using the factory’s computer, the printer 1 may include a ROM writer. In that case, a factory worker uses the printer 1 to write the parameter data into the memory 96. Specifically, the roll holder 91 including the memory 96 is mounted on the printer 1, and the CPU 71 writes the parameter data via the ROM writer.

Next, inspection of the roll units 9 is performed (S117). The roll unit 9 that passes inspection is packaged (S118). The packaged roll unit 9 is then shipped from the printer manufacturer’s factory to the printer manufacturer’s warehouse department (S119).

At the warehouse department, the roll units 9 received from the factory are repackaged into smaller units as needed (S120). Then, the repackaged roll units 9 are shipped from the warehouse department to the user (S121). The roll unit 9 is mounted in the printer 1 by the user (S122). Since the memory 96 of the roll holder 91 stores parameter data suitable for printing with the printer 1, the printing result on the media sheet 92 is favorable.

In the above embodiments, an attachment step (for example, Steps S16, S36, S56, S76, S96, and S116) is performed in which the roll 90 with the media sheet 92 wound thereon is attached to the roll holder 91. The roll holder 91 includes the memory 96. Therefore, information related to various rolls 90 can be written into the memory 96 by a writing device such as a computer.

When the attachment step is performed by the roll provider, the roll provider can supply the roll and attach the roll to the roll holder.

When the attachment step is performed by the holder provider, the holder provider can supply the roll holder 91 and attach the roll 90 to the roll holder 91.

A writing step (for example, Steps S18, S37, S58, S77, S98, and S117) for writing information related to various rolls 90 into the memory 96 of the roll holder 91 is performed with the roll 90 attached to the roll holder 91. Therefore, information suitable for the roll attached to the roll holder can be written into the memory.

In the above embodiments, the roll 90 attached to the roll holder 91 is shipped after information has been written into the memory 96. Therefore, the roll 90 with the roll holder 91 including the memory 96, which stores suitable information for the roll 90, is shipped.

When the roll provider (, who provides with roll 90) ships the roll unit 9 including the roller 90 being attached to the roll holder 91, the roll provider can ship the roll 90 being attached to the roll holder 91 including the memory 96, which stores suitable information for the roll 90.

In the writing step, the writing into the memory 96 is performed using a data file including printing parameters. Therefore, a data file including printing parameters suitable for printing by the printer 1 onto the media sheet 92 can be written into the memory 96. As a result, printing on the media sheet 92 is performed properly.

When the data file of parameter data is supplied from the holder provider to the roll provider, the roll provider can write parameter data suitable for printing by the printer 1 into the memory 96.

When the parameter data file is a batch file executed by the printer 1, reverse engineering of the data file can be prevented.

When the roll provider is different from the holder provider, the roll provider can receive provisions of the rolls 90 from a roll provider that is different from the holder provider.

The holder provider may directly sell the rolls 90 fitted with the roll holder 91.

In the above embodiments, a data file including sample printing parameter data is generated. Then, the parameter data is written into the memory 96, and test printing is performed by the printer 1. When the test printing results show no issues, the data file is sent for use in the writing step. Therefore, a data file that has passed the test printing can be used in the writing step to the mass produce roll 90 being attached to roll holder 91.

In the above description, the media sheet 92 is an example of the “sheet” in the present disclosure. Step S33 is an example of the “holder providing step” in the present disclosure. Steps S16, S36, S56, S76, S96, and S116 are examples of the “attachment step” and “attachment process” of the present disclosure. Steps S18, S37, S58, S77, S98, and S117 are examples of the “writing step” and “writing process” of the present invention. Steps S39, S79, and S121 are examples of the “shipping step” of the present disclosure. Step S79 is an example of the “selling step” of the present disclosure.

Steps S15, S55, S75, S95, and S115 are examples of the “roll providing step” of the present disclosure. Step S33 is also an example of the “roll holder selling step.” Steps S17, S57, and S97 are examples of the “data file creation step.” Steps S18, S60, and S100 are examples of the “data file sending process.” Steps S19, S59, and S99 are examples of the “test printing step.”

### Modifications

The present disclosure is not limited to the embodiments described above, and various modifications may be made. The printing method of the printer 1 is not limited to a thermal printing method; a thermal transfer method, in which an ink ribbon is heated by the head 14 to perform printing, may also be used. The data file of the parameter data may be encrypted. Transmission of the parameter data file may be performed without using the Internet, for example, by sending a storage medium such as a USB memory, SD memory card, or DVD on which the parameter data file is stored.

A third party different from the holder provider may sell the rolls 90 attached to the roll holders 91. In this case, sales of the rolls 90 attached to the roll holders 91 may be entrusted to the third party. The holder provider may also sell the roll holders 91 equipped with the memory 96 to the third party. In this case, by selling the roll holders 91 equipped with the memory 96, the third party can be made to supply the rolls 90 fitted with the roll holders 91.

The roll provider may also sell the rolls 90 fitted with the roll holders 91. In this case, the roll provider can directly carry out sales of the rolls 90 fitted with the roll holders 91.

The holder provider may also sell the roll holders 91 including the memory 96 to the roll provider. In this case, the roll provider can be made to carry out the sale of the rolls 90 attached to the roll holders 91.

Instead of the CPU 71, a microcomputer, an ASIC (Application Specific Integrated Circuits), an FPGA (Field Programmable Gate Array), or the like may be used as the processor.

While the disclosure has been described in detail with reference to the specific embodiment thereof, this is merely an example, and various changes, arrangements and modifications may be applied therein without departing from the spirit and scope of the disclosure.

What is claimed is:

1. A method comprising:
providing a roll holder including a memory, the roll holder configured to allow a roll around which a sheet is wound to be attached;
attaching the roll to the provided roll holder; and
writing, by a writing device, information related to the roll into the memory.

2. The method according to claim 1,
wherein the providing the roll holder is performed by a roll provider, and
wherein the attaching the roll to the provided roll holder is performed by the roll provider.

3. The method according to claim 1,
wherein the providing the roll holder is performed by a holder provider, and
wherein the attaching the roll to the provided roll holder is performed by the holder provider.

4. The method according to claim 1, wherein the writing step is performed in a state where the roll is attached to the roll holder.

5. The method according to claim 4, further comprising:
shipping the roll to which the roll holder is attached after information is written into the memory.

6. The method according to claim 5,
wherein the providing the roll holder is performed by a roll provider, and
wherein the shipping the roll is performed by the roll provider.

7. The method according to claim 1,
wherein the writing information into the memory is performed using a data file including printing parameter.

8. The method according to claim 7, further comprising:
providing, by a roll provider, the roll,
wherein the providing the roll holder is performed by a holder provider, and
wherein the data file is supplied from the holder provider to the roll provider.

9. The method according to claim 7,
wherein the data file is a batch file executed by a printer that performs printing on the sheet.

10. The method according to claim 1, further comprising:
providing, by a roll provider, the roll,
wherein the providing the roll holder is performed by a holder provider which is different from the roll provider.

11. The method according to claim 1,
wherein the providing the roll holder is performed by a holder provider,
wherein the method further comprises:
selling, by the holder provider, the roll being attached to the roll holder.

12. The method according to claim 1,
wherein the providing the roll holder is performed by a holder provider,
wherein the method further comprises:
selling, by a third party, which is different from the holder provider, the roll being attached to the roll holder.

13. The method according to claim 12, further comprises:
selling, by the holder provider, the roll holder including the memory to the third party.

14. The method according to claim 1,
wherein the providing the roll is performed by a roll provider,
wherein the method further comprises:
selling, by the roll provider, the roll being attached to the roller holder.

15. The method according to claim 14,
wherein the providing the roll holder is performed by a holder provider,
wherein the method further comprises:
selling, by the holder provider, the roller holder including the memory to a roll provider providing the roll.

16. The method according to claim 1, further comprising:
generating a data file including sample printing parameter;
writing the data file into the memory and performing test printing onto the sheet by a printer; and
sending the data file that has no issues in the test printing result for the writing the data file as the information into the memory.

17. A method for manufacturing a roll attached to a roll holder, the method comprising:
attaching a roll around which a sheet is wound to the roll holder including a memory; and
writing, by a writing device, information related to the roll into the memory.

18. The method according to claim 17,
wherein the attaching the roll to the roll holder is performed by a roll provider that provides the roll.

19. The method according to claim 17,
wherein the attaching the roll to the roll holder is performed by a holder provider that provides the roll holder.

20. The method according to claim 17,
wherein the writing information into the memory is performed in a state where the roll is attached to the roll holder.
